(19) United States
(12) Patent Application Publication
(10) Pub. No.: US 2026/0337789 A1
(43) Pub. Date: Oct. 29, 2026

(54) ELECTROLYZER SYSTEM AND METHOD OF OPERATING THEREOF WITH OXYGEN EXHAUST FLOW RESTRICTION

(71) Applicant: Bloom Energy Corporation, San Jose, CA (US)

(72) Inventors: David WEINGAERTNER, Sunnyvale, CA (US); Jessica MAHLER, Palo Alto, CA (US); Ryan JOHNSON, San Jose, CA (US)

(21) Appl. No.: 19/551,007

(22) Filed: Feb. 26, 2026

Related U.S. Application Data
(60) Provisional application No. 63/767,245, filed on Mar. 5, 2025.

(51) Int. Cl. C25B 1/042; C25B 9/60; C25B 9/73; C25B 13/07; C25B 15/08

(52) U.S. Cl. CPC C25B 1/042; C25B 9/60; C25B 9/73; C25B 13/07; C25B 15/083

(57) ABSTRACT

An electrolyzer system includes a hotbox, stacks of electrolyzer cells located in the hotbox and configured to receive steam and air, and to output a hydrogen stream and an oxygen exhaust, an air recuperator heat exchanger surrounding the stacks in the hotbox and configured to heat the air received by the stacks by extracting heat from the oxygen exhaust output from the stacks, an exhaust conduit configured to output the oxygen exhaust from the hotbox, and an exhaust restrictor configured to increase back pressure of oxygen exhaust flow between an outlet of the air recuperator heat exchanger and the exhaust conduit.

### FIELD

The embodiments of the present invention are generally directed to electrolyzer systems and methods of operating the same using oxygen exhaust flow restriction.

### BACKGROUND

In a solid oxide electrolyzer cell (SOEC), a cathode electrode is separated from an anode electrode by a solid oxide electrolyte. When a SOEC is used to produce hydrogen through electrolysis, a positive potential is applied to the air side of the SOEC and oxygen ions are transported from the fuel (e.g., steam) side to the air side. Throughout this specification, the SOEC anode will be referred to as the air electrode, and the SOEC cathode will be referred to as the fuel electrode. During SOEC operation, water (e.g., steam) in the fuel stream is reduced (H₂O+2e⁻→O²⁻+H₂) to form H₂ gas and O²⁻ ions, the O²⁻ ions are transported through the solid electrolyte, and then oxidized (e.g., by an air inlet stream) on the air side (O²⁻ to O₂) to produce molecular oxygen (e.g., oxygen enriched air).

### SUMMARY

In various embodiments, an electrolyzer system includes a hotbox, stacks of electrolyzer cells located in the hotbox and configured to receive steam and air, and to output a hydrogen stream and an oxygen exhaust, an air recuperator heat exchanger surrounding the stacks in the hotbox and configured to heat the air received by the stacks by extracting heat from the oxygen exhaust output from the stacks, an exhaust conduit configured to output the oxygen exhaust from the hotbox, and an exhaust restrictor configured to increase back pressure of oxygen exhaust flow between an outlet of the air recuperator heat exchanger and the exhaust conduit.

In various embodiments, a method of operating an electrolyzer system includes providing steam and air to stacks of electrolyzer cells located in a hotbox to generate a hydrogen stream and an oxygen exhaust; heating the air provided to the stacks by extracting heat from the oxygen exhaust output from the stacks in an air recuperator heat exchanger surrounding the stacks in the hotbox; flowing the air exhaust from the air recuperator heat exchanger though an exhaust restrictor which increases back pressure of the oxygen exhaust flow; and outputting the oxygen exhaust from the hotbox through an exhaust conduit.

### BRIEF DESCRIPTION OF THE FIGURES

FIG. 1A is a perspective view of a solid oxide electrolyzer cell (SOEC) stack, and FIG. 1B is a side cross-sectional view of a portion of the stack of FIG. 1A.

FIG. 2 is a schematic view of an electrolyzer system according to various embodiments of the present disclosure.

FIG. 3 is a perspective view of a hotbox, according to various embodiments of the present disclosure, and FIG. 4 is a perspective view of the hotbox, with its outer shell removed.

FIG. 5A is a vertical cross-sectional view of components inside the hotbox showing air flow through the hotbox of FIGS. 3 and 4, FIG. 5B is a vertical cross-sectional view of components inside the hotbox showing oxygen exhaust flow through the hotbox, FIG. 5C is a schematic top view of the hotbox, and FIG. 5D is a side view of an exhaust restrictor that may be included in the hotbox.

FIG. 6A is a schematic top view of a hotbox including an alternative exhaust restrictor, according to various embodiments of the present disclosure, FIG. 6B is a side view of a first portion of the exhaust restrictor of FIG. 6A, and FIG. 6C is a side view of a second portion of the exhaust restrictor of FIG. 6A.

FIG. 7 is a schematic top view of a hotbox including an alternative exhaust restrictor, according to various embodiments of the present disclosure.

### DETAILED DESCRIPTION

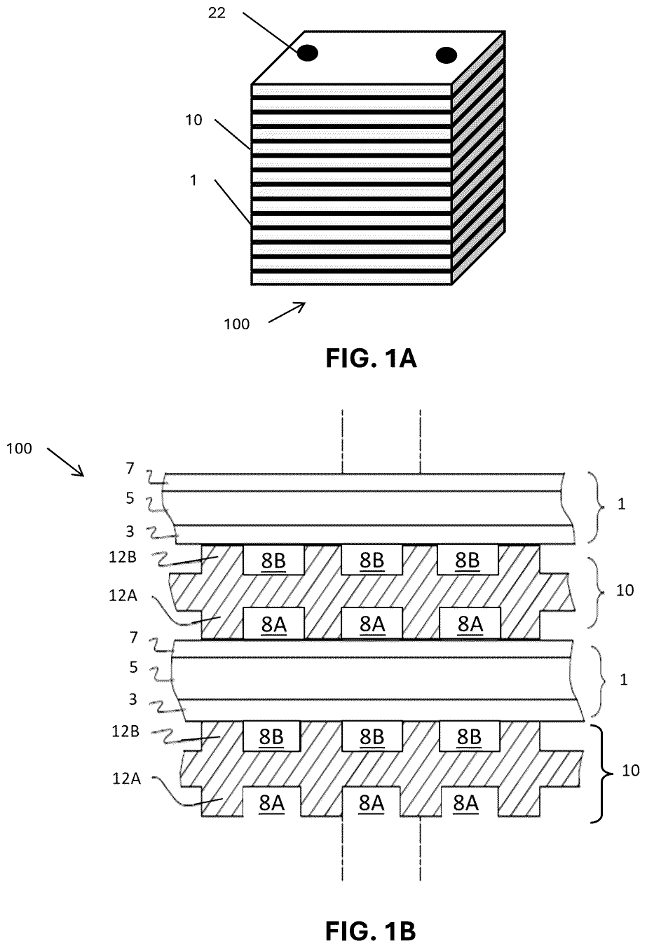

FIG. 1A is a perspective view of an electrolyzer cell stack 100, such as a solid oxide electrolyzer cell (SOEC) stack, and FIG. 1B is a side cross-sectional view of a portion of the stack 100 of FIG. 1A. Referring to FIGS. 1A and 1B, the stack 100 includes multiple electrolyzer cells (e.g., SOECs) 1 that are separated by interconnects 10, which may also be referred to as gas flow separator plates or bipolar plates. Each electrolyzer cell 1 includes an air electrode 3, an electrolyte 5, such as a solid oxide electrolyte for a SOEC, and a fuel electrode 7. The stack 100 also includes internal fuel riser channels 22.

Each interconnect 10 electrically connects adjacent electrolyzer cells 1 in the stack 100. In particular, an interconnect 10 may electrically connect the fuel electrode 7 of one electrolyzer cell 1 to the air electrode 3 of an adjacent electrolyzer cell 1. FIG. 1B shows that the lower electrolyzer cell 1 is located between two interconnects 10.

Various materials may be used for the air electrode 3, electrolyte 5, and fuel electrode 7. For example, the air electrode 3 may comprise an electrically conductive material, such as an electrically conductive perovskite material, such as lanthanum strontium manganite (LSM). Other conductive perovskites, such as LSCo, etc., or metals, such as Pt, may also be used. The electrolyte 5 may comprise a stabilized zirconia, such as scandia stabilized zirconia (SSZ) or yttria stabilized zirconia (YSZ), yttria-ceria-stabilized zirconia (YCSZ), ytterbia-ceria-scandia-stabilized zirconia (YbCSSZ), or blends thereof. In YbCSSZ, scandia may be present in an amount equal to 9 to 11 mol %, such as 10 mol %, ceria may present in amount greater than 0 and equal to or less than 3 mol %, for example 0.5 mol % to 2.5 mol %, such as 1 mol %, and ytterbia may be present in an amount greater than 0 and equal to or less than 2.5 mol %, for example 0.5 mol % to 2 mol %, such as 1 mol %, as disclosed in U.S. Pat. No. 8,580,456, which is incorporated herein by reference. Alternatively, the electrolyte 5 may comprise another ionically conductive material, such as a doped ceria. The fuel electrode 7 may comprise a cermet comprising a nickel containing phase and a ceramic phase. The nickel containing phase may consist entirely of nickel in a reduced state. The ceramic phase may comprise a stabilized zirconia, such as yttria and/or scandia stabilized zirconia and/or a doped ceria, such as gadolinia, yttria and/or samaria doped ceria. The electrodes and the electrolyte may each comprise one or more sublayers of one or more of the above described materials.

Each interconnect 10 includes fuel ribs 12A that at least partially define fuel channels 8A, and air ribs 12B that at least partially define air channels 8B. The interconnect 10 may operate as a gas-fuel separator that separates a fuel, such as steam, flowing to the fuel electrode 7 of one electrolyzer cell 1 in the stack 100 from oxidant, such as air, flowing to the air electrode 3 of an adjacent electrolyzer cell 1 in the stack 100. At either end of the stack 100, there may be an air end plate or fuel end plate (not shown) for providing air or fuel, respectively, to the end electrode. Alternatively, the air end plate or fuel end plate may comprise the same interconnect structure used throughout the stack.

Each interconnect 10 may be made of or may contain electrically conductive material, such as a metal alloy (e.g., chromium-iron alloy) which has a similar coefficient of thermal expansion to that of the solid oxide electrolyte in the cells (e.g., a difference of 0-10%). For example, the interconnects 10 may comprise a metal (e.g., a chromium-iron alloy, such as 4-6 weight percent iron, optionally 1 or less weight percent yttrium and balance chromium alloy). Alternatively, any other suitable conductive interconnect material, such as stainless steel (e.g., ferritic stainless steel, SS446, SS430, etc.) or iron-chromium alloy (e.g., Crofer™ 22 APU alloy which contains 20 to 24 wt. % Cr, less than 1 wt. % Mn, Ti and La, and balance Fe, or ZMG™ 232L alloy which contains 21 to 23 wt. % Cr, 1 wt. % Mn and less than 1 wt. % Si, C, Ni, Al, Zr and La, and balance Fe) may be used.

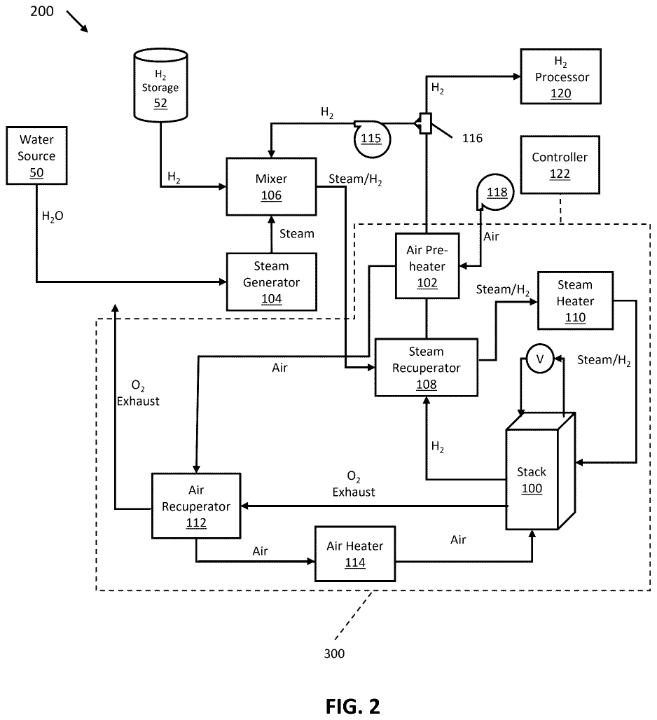

FIG. 2 is a schematic view of an electrolyzer system 200, according to various embodiments of the present disclosure. Referring to FIGS. 1A, 1B, and 2, the system 200 may include one or more electrolyzer cell stacks 100 or columns, such as plural solid oxide electrolyzer cell (SOEC) stacks or columns, as described with respect to FIGS. 1A and 1B. The system 200 may also include a steam recuperator heat exchanger 108, a steam heater 110, an air recuperator heat exchanger 112, and an air heater 114. The system 200 may also include an optional mixer 106 that is fluidly connected to a steam generator 104. The steam generator 104 may comprise a portion of the system 200. Alternatively, the steam generator 104 may comprise a component (e.g., building or factory steam source) that is located external to the system 200.

The system 200 may include a hotbox 300 that houses various components, such as the stack 100, steam recuperator 108, steam heater 110, air recuperator 112, and/or air heater 114. In some embodiments, the hotbox 300 may include multiple stacks 100 or multiple columns. Each column may include one or more stacks 100.

During operation, the stack 100 may be provided with steam (e.g., steam inlet stream) and electric power (e.g., current or voltage) from an external power source. In particular, the steam may be provided to the fuel electrodes 7 of the electrolyzer cells 1 of the stack 100, and the power source may apply a voltage between the fuel electrodes 7 and the air electrodes 3, in order to electrochemically split water (e.g., steam) molecules and generate hydrogen (e.g., H₂) and oxygen (e.g., O₂). Air may also be provided to the air electrodes 3, in order to sweep the oxygen from the air electrodes 3. As such, the stack 100 may output a hydrogen stream (i.e., a hydrogen containing product stream which includes hydrogen and any remaining water) and an oxygen-rich exhaust stream, such as an oxygen enriched air stream (“oxygen exhaust”).

Water output from a water source 50 (e.g., municipal water supply or a dedicated deionized water source) may be provided to the steam generator 104. The steam generator 104 heats the water to convert the water into steam.

The steam output from the steam generator 104 may be provided to the steam recuperator 108. However, if the system 200 includes the optional mixer 106, the steam may be provided to the mixer 106 prior to being provided to the steam recuperator 108. The mixer 106 may be configured to mix the steam with hydrogen received from a hydrogen storage device 52 and/or with a portion of the hydrogen stream output from the stack 100. In some embodiments, the hydrogen may be provided from hydrogen storage device 52 during system startup and/or shut-down operation modes. For example, during startup and shut-down modes, the hydrogen may be provided from the hydrogen storage device 52, while during a steady-state mode, the flow of hydrogen from the hydrogen storage device 52 may be stopped. Instead, hydrogen may be provided into the mixer 106 by diverting a portion of the hydrogen stream (i.e., hydrogen exhaust stream) generated by the stack 100 using a hydrogen recycle blower 115. In particular, the system 200 may include a hydrogen separator 116, such as a splitter and/or valve, configured to selectively divert a portion of the generated hydrogen stream to the mixer 106, during the steady-state operation mode.

The steam recuperator 108 may be a heat exchanger configured to recover heat from the hydrogen stream output from the stack 100. The steam output from the steam recuperator 108 may be provided to the steam heater 110 which is located downstream from the steam recuperator 108, as shown in FIG. 2. The steam heater 110 may include a heating element, such as a resistive or inductive heating element. The steam heater 110 may be configured to heat the steam to a temperature above the operating temperature of the stack 100. Heat may also be transported directly from the steam heater 110 to the stacks 100 by radiation (i.e., by radiant heat transfer).

The oxygen exhaust output from the stack 100 may be provided to the air recuperator 112. The air recuperator 112 may be provided with ambient air by an air blower 118. The air recuperator 112 may be configured to heat the air using heat extracted from the oxygen exhaust. In some embodiments, the ambient air may be filtered to remove contaminants, prior to being provided to the air recuperator 112 or the air blower 118.

Air output from the air recuperator 112 may be provided to the air heater 114. The air heater may include a resistive or inductive heating element configured to heat the air to a temperature exceeding the operating temperature of the stack 100. Heat may also be transported directly from the air heater to the stack 100 by radiation.

The system 200 may also include an optional air preheater heat exchanger 102. In particular, the air preheater 102 may be configured to preheat air provided to the hotbox 300 by the air blower 118 using heat from the hydrogen stream output from the steam recuperator 108. Thus, the air preheater 102 functions as a hydrogen stream product cooler. It cools the hydrogen stream to a lower temperature to lower overall power consumption and to reduce its temperature below the maximum temperature of the steam recycle blower 115. The heated air stream is provided from the air preheater 102 to the air recuperator 112.

The hydrogen stream output from the hotbox 300 may be compressed and/or purified in a hydrogen processor 120 in order to remove from about 70% to about 90% of the hydrogen from the hydrogen stream. A remaining unpumped effluent from the hydrogen processor 120 is a water rich stream that is already fully vaporized. This water rich stream may be optionally fed to a blower for recycle into the mixer 106 or the stream recuperator 108.

In various embodiments, the hydrogen processor 120 may include at least one electrochemical hydrogen pump (e.g., a high temperature hydrogen pump that operates at a temperature of from about 120 °C to about 150 °C), liquid ring compressor, diaphragm compressor, other compression device, or combination thereof. For example, the hydrogen processor may include a series of electrochemical hydrogen pumps, which may be disposed in series and/or in parallel with respect to a flow direction of the hydrogen stream, in order to compress the hydrogen stream. Electrochemical compression may be more electrically efficient than traditional compression. The final product from compression may still contain traces of water. As such, the hydrogen processor 120 may include a dewatering device, such as a temperature swing adsorption reactor or a pressure swing adsorption reactor, to remove this residual water, if necessary.

According to various embodiments, the system 200 may also include a controller 122, such as a central processing unit, which is configured to control the operation of the system 200. For example, the controller 122 may be wired or wirelessly connected to various elements of the system 200 to control the same.

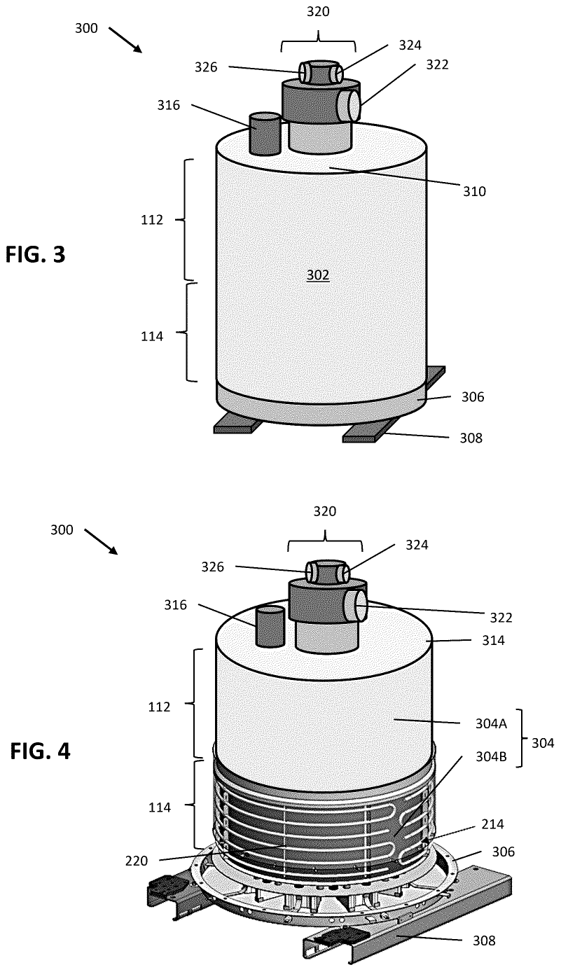

FIG. 3 is a perspective view of a hotbox 300, according to various embodiments of the present disclosure, and FIG. 4 is a perspective view of the hotbox 300 of FIG. 3 with its outer shell removed. Referring to FIGS. 3 and 4, the hotbox 300 may include an outer shell 302 and an inner shell 304 that are disposed over a base pan 306. The inner shell 304 may include an upper inner shell 304A and a lower inner shell 304B.

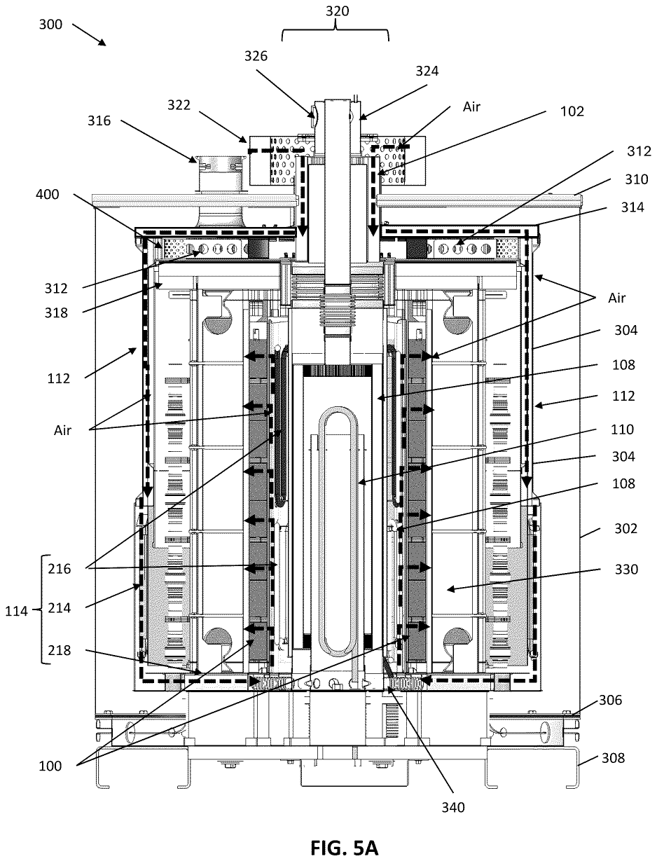

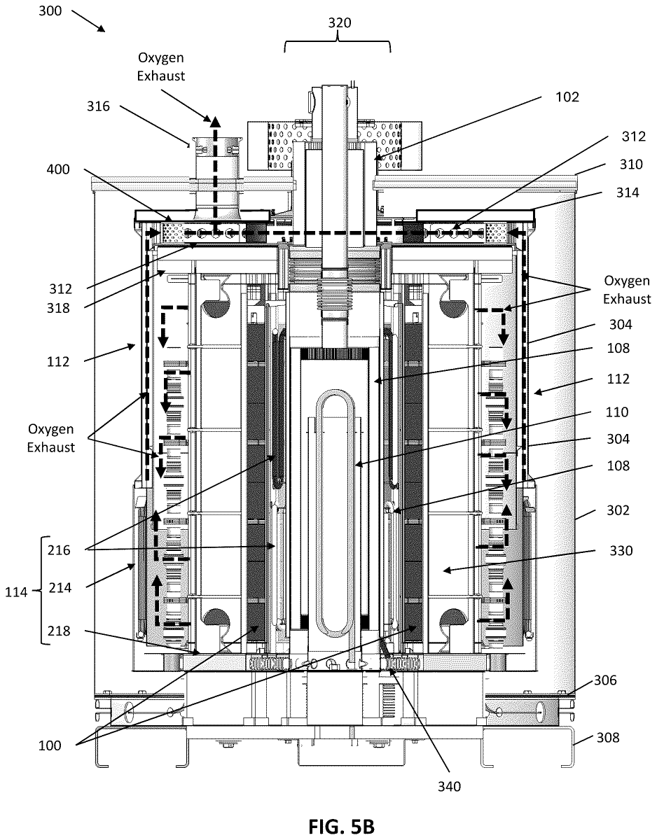

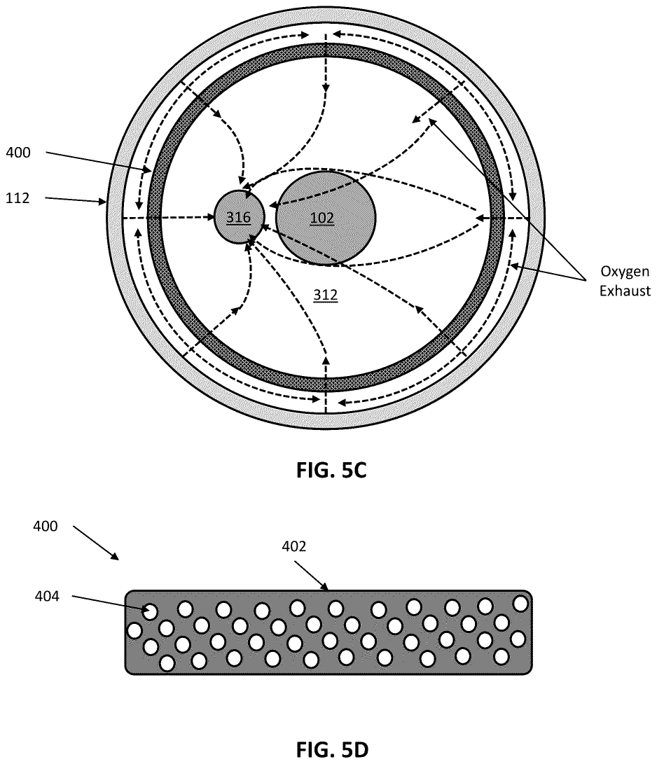

An outer cover plate 310 may be disposed above the outer shell 302 and an inner cover plate 314 (also shown in FIG. 5A) may be disposed above the inner shell 304. The base pan 306 may be disposed on a support frame 308. In one embodiment, the support frame 308 may comprise hollow rails which provide access for a forklift to raise and move the hotbox 300. A central column 320 may also extend through the inner cover plate 314 and the outer cover plate 310. An oxygen exhaust conduit (i.e., an oxygen-enriched air exhaust conduit) 316 extends through the inner cover plate 314 and the outer cover plate 310. An air inlet conduit 322, a steam inlet conduit 324, and a hydrogen outlet conduit 326 may be disposed on the central column 320.

The above described air recuperator 112 may be disposed in an upper portion of the hotbox 300, and the above described air heater 114 may be disposed in a lower portion of the hotbox 300. The air heater 114 may include one or more peripheral heating elements 214 disposed between the lower inner shell 304B and the outer shell 302. The peripheral heating elements 214 may include resistive heating elements which are powered by an external current or voltage. The peripheral heating elements 214 may extend laterally in a serpentine pattern. However, any suitable coil pattern or configuration may be used. The peripheral heating elements 214 may be held in position by support elements 220. The support elements 220 may be configured to maintain a spacing between the inner shell 304 and the outer shell 302. In some embodiments, the support elements 220 may comprise brackets formed of a dielectric material that can withstand high temperatures, such as a ceramic material.

According to various embodiments, the present inventors determined that a single oxygen exhaust conduit 316 may provide sufficient oxygen exhaust flow for an electrolyzer hotbox 300, which reduces hotbox 300 manufacturing costs compared to a hotbox that has plural oxygen exhaust conduits. For example, the present inventors determined that a single oxygen exhaust conduit 316 having a relatively small diameter (e.g., a diameter of 1 to 2 inches, such as a 1.5 inch diameter) would be sufficient to accommodate about 1200 standard liters per minute (slm) of oxygen-enriched air exhaust flow at 300 °C, with a pressure drop of only about 0.04 pounds per square inch (psi).

However, the present inventors also determined that using a single oxygen exhaust conduit 316 which is spaced radially from the central column 320 (e.g., which is laterally radially offset from a central vertical axis of a cylindrical hotbox 300) may result in uneven circumferential oxygen exhaust (i.e., oxygen-enriched air) flow, as compared to a hotbox 300 containing plural exhaust conduits located around a circumference of the central column 320. For example, a disproportionate amount of oxygen exhaust may flow through a sector of the air recuperator 112 closest to the oxygen exhaust conduit 316 in hotbox 300 containing a single oxygen exhaust conduit. Various embodiments provide a hotbox 300 which contains an exhaust restrictor 400 which provides a more uniform radial oxygen exhaust distribution through the cylindrical air recuperator 112 when the hotbox 300 contains a single oxygen exhaust conduit 316 that is spaced radially from the central column 320.

FIG. 5A is a cross-sectional view showing and air flow through the hotbox 300 of FIGS. 3 and 4, FIG. 5B is a cross-sectional view showing oxygen exhaust flow through the hotbox 300, FIG. 5C is a schematic top view of the hotbox 300, and FIG. 5D is a side view of an exhaust restrictor 400 that may be included in the hotbox 300.

Referring to FIGS. 2, 3, 4 and 5A, the electrolyzer cell stacks 100 may surround the central column 320. In this embodiment, the stacks 100 are arranged into electrolyzer cell columns, each of which includes a plurality of the stacks 100. However, in other embodiments, each column may contain only one stack 100. Side baffle plates 330, such as ceramic side baffle plates, may be disposed on lateral sides of the stacks 100 or columns.

The cylindrical air recuperator 112 may surround the stacks 100. The inner shell 304 of the hotbox 300 may form an outer surface of the air recuperator 112. One or more ceramic plates 318 may be disposed over the stacks 100 and under the inner cover plate 314. An optional cover support 312 may be disposed between the inner cover plate 314 and the ceramic plate(s) 318. The cover support 312 may include at least one perforated support structure (e.g., perforated support rails) and may at least partially define an oxygen exhaust flow space between the inner cover plate 314 and the ceramic plate(s) 318 and surrounding a portion of the central column 320.

The air heater 114 may include the peripheral heating elements 214 and may optionally include one or more central heating elements 216 and/or one or more bottom heating elements 218. The heating elements 214, 216, 218 may be electrically resistive elements, such as AC or DC heating coils, or inductive heating elements. The peripheral heating elements 214 may surround bottom portions of the stacks 100. The central heating elements 216 may surround the central column 320 and may be surrounded by the stacks 100. The central heating elements 216 may also be used to heat the central column 320. The bottom heating elements 218 may be disposed below the stacks 100.

During operation, steam may be provided to the hotbox via the steam inlet conduit 324. The steam may then flow downward through the central column 320 and through the steam recuperator 108. The steam may then flow back upward into the central column 320 and then back downward past the steam heater 110 located in the central column 320. The heated steam is then provided to a distribution hub 340 located over base pan 306 and under the stacks 100. The heated steam is distributed from the distribution hub 340 upward to each of the stacks 100 (e.g., to each column of the stacks 100). The steam may then be provided to the fuel (e.g., cathode) electrodes 7 of the electrolyzer cells (e.g., SOECs) 1 of the stacks 100. Hydrogen streams generated by the stacks 100 (e.g., generated at the fuel electrodes 7 of the SOECs 1 in the stacks 100) may be provided back to the distribution hub 340. The hydrogen stream may include the hydrogen product and unreacted steam output from the stacks 100.

The distribution hub 340 may provide the hydrogen stream to the steam recuperator 108, where the hydrogen stream flows upward through an outer chamber of the steam recuperator 108. The hydrogen stream may heat steam flowing downward through an inner chamber of the steam recuperator 108. The hydrogen stream may exit the steam recuperator 108 and flow upwards in the central column 320 into the air preheater 102. In particular, the hydrogen stream may heat the air inlet stream flowing through the air preheater 102.

Referring to FIG. 5A, air (i.e., air inlet stream) may be provided to the hotbox 300 through the air inlet conduit 322. The air may be provided to a first chamber of the air preheater 102, where the air may be preheated by the hydrogen stream flowing through a second chamber of the air preheater 102. The heated air may flow out of the air preheater 102, laterally outward through space between the top of the inner shell 304 of the hotbox 300 and the bottom of the inner cover plate 314, and then into the air recuperator 112.

In particular, the air may flow downwards through an outer chamber of the air recuperator 112 to the air heater 114. The air may be heated while flowing downward past the peripheral heating elements 214 of the air heater 114, radially inward across the bottom of the hotbox 300 past the optional bottom heating elements 218, and upward along the central column 320 past the central heating elements 216 of the air heater 114. The heated air may then exit the air heater 114 (e.g. flow laterally outward of the central heating elements 216) and flow radially outward into the stacks 100. The temperature of the air may be adjusted by adjusting the power applied to one or more of the heating elements 214, 216, 218. The air is combined at the air electrodes 3 of the electrolyzer cells 1 (e.g., SOECs) with the oxygen ions transported through the SOEC electrolyte 5 from the fuel electrode (i.e., cathode) 7 side of the SOECs to form the oxygen-enriched air stream (i.e., oxygen exhaust).

As shown in FIGS. 5B and 5C, the oxygen exhaust generated at the air electrodes 3 of the electrolyzer cells 1 in the stacks 100 may flow radially outward from the stacks 100 and then into an inner chamber of the air recuperator 112. The air recuperator 112 may heat the air (i.e., the air inlet stream) in an outer chamber of the air recuperator 112 using heat extracted from the oxygen exhaust in the inner chamber of the air recuperator 112. The oxygen exhaust may then flow upwards out of an outlet at the top of the air recuperator 112, into a space between the top surface of the inner shell 304 and the ceramic plate(s) 318, and then into the exhaust conduit 316. In particular, the oxygen exhaust may flow through the exhaust flow space in the cover support 312 and may then exit the hotbox 300 via the exhaust conduit 316. In some embodiments, the exhaust conduit 316 may have relatively small diameter less than 10 cm, such as a diameter ranging from about 2 cm to about 8 cm, such as from about 3 cm to about 5 cm, such as from about 3.5 cm to about 4 cm.

As shown in FIGS. 5B-5D, in order to increase oxygen exhaust radial flow uniformity through the air recuperator 112, the hotbox 300 may include an exhaust restrictor 400 disposed between the circular outlet of the air recuperator 112 and the cover support 312. The exhaust restrictor 400 may comprise any component that increases back pressure of the oxygen exhaust flow exiting the air recuperator 112.

In one embodiment, the exhaust restrictor 400 may include a cylindrical body 402 having through holes (i.e., through-apertures) 404 formed therein. The exhaust restrictor 400 forms a partial barrier between the outlet of the air recuperator 112 and the cover support 312, by forcing the oxygen exhaust to flow through the through holes 404. For example, by partially blocking and increasing back pressure of the oxygen exhaust flow, the exhaust restrictor 400 may generate a circumferential oxygen exhaust in the air recuperator 112. As such, the exhaust restrictor 400 may prevent a disproportionate amount of oxygen exhaust from flowing through a radial sector of the air recuperator 112 located closest to the exhaust conduit 316. In other words, the exhaust restrictor 400 may reduce the amount of oxygen exhaust that flows along relatively short routes between the outlet of the air recuperator 112 and the exhaust conduit 316, thereby increasing circumferential oxygen exhaust flow uniformity through the air recuperator 112.

The exhaust restrictor 400 may induce a pressure drop in the air exhaust stream flowing through exhaust space of the cover support 312 and may also increase the pressure of the upstream air exhaust output from the stacks 100 and/or the upstream air provided to the stacks 100. In other words, the pressure drop generated by the exhaust restrictor 400 may also increase back pressure of air flow through the stacks 100. Accordingly, the exhaust restrictor 400 may increase the pressure applied to the air electrode 3 sides of the electrolyzer cell 1 electrolytes 5 of the stacks 100.

The size, shape and/or density of through holes 404 included in the exhaust restrictor 400 may be selected to provide a desired amount of flow restriction and/or circumferential oxygen exhaust flow uniformity. While the holes 404 shown in FIG. 5D are circular, any other non-circular shape (e.g. square, rectangular slot, ovoid slot, etc.) may be used. For example, in some embodiments the exhaust restrictor 400 may be configured to generate a pressure drop in the oxygen exhaust ranging from about 0.6 psi to about 0.2 psi, such as from about 0.5 psi to about 0.3 psi, or about 0.4 psi.

In some embodiments, the amount of increase in back pressure may be set based on an amount of pressure that is applied to the fuel electrode 7 sides of the electrolyzer cell 1 electrolytes 5 by the steam and/or hydrogen streams, in order to minimize a cell pressure differential across the cell electrolytes (i.e., between fuel and air sides of the electrolytes 5). In some embodiments, the exhaust restrictor 400 may be configured such that the electrolyzer cell 1 pressure difference between the air electrode 3 side and the fuel electrode 7 side is less than about 0.3 psi, such as from about 0.01 psi to about 0.25 psi, from about 0.02 psi to about 0.2 psi, or from about 0.05 psi to about 0.1 psi, with the fuel electrode 7 side pressure being higher than the air electrode 3 side pressure.

The reduced electrolyzer cell 1 pressure difference may prevent or reduce electrolyzer cell damage, such as electrolyte 5 fracturing, which may occur at high electrolyzer cell pressure differences. The reduced electrolyzer cell 1 pressure difference may also reduce the likelihood of stack seal leakage. As such, the exhaust restrictor 400 may beneficially increase the operating lifespan of the stacks 100.

In some embodiments, the exhaust conduit 316 may be disposed relatively close to the central column 320. For example, the exhaust conduit 316 may be disposed closer in the radial direction to the central column 320 than to the edge of the inner shell 304 of the hotbox 300. Locating the exhaust conduit 316 closer to the central column 320 may also increase circumferential oxygen exhaust flow uniformity through the air recuperator 112 by reducing a variation in the minimum distance between a particular portion of the outlet of the air recuperator 112 and the exhaust conduit 316.

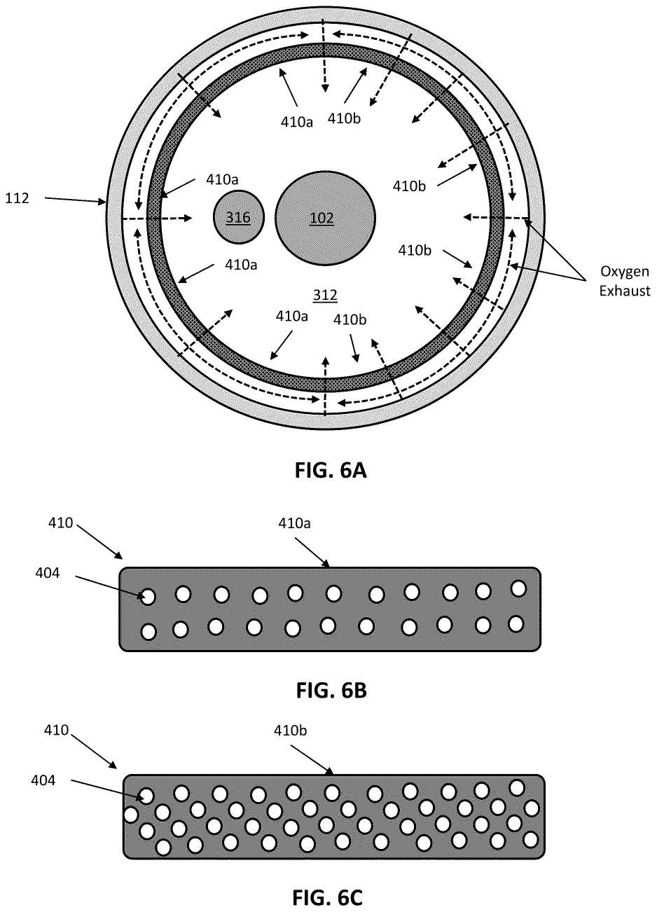

FIG. 6A is a schematic top view of a hotbox 300 including an alternative exhaust restrictor 410, according to various embodiments of the present disclosure, FIG. 6B is a side view of a first portion 410a of the exhaust restrictor 410 of FIG. 6A, and FIG. 6C is a side view of a second portion 410b of the exhaust restrictor 410 of FIG. 6A.

Referring to FIGS. 6A-6C, the first portion 410a of the exhaust restrictor 410 may be disposed closer to the exhaust conduit 316 than the second portion 410b. For example, the first portion 410a of the exhaust restrictor 410 may be disposed on the same lateral side of the hotbox as the exhaust conduit 316, while the second portion 410b may be disposed on the opposite lateral side of the hotbox 300 from the exhaust conduit 316. The first portion 410a may have a lower density of through holes 404 than the second portion 410b. As such, the first portion 410a may impart a higher amount of back pressure than the second portion 410b to the oxygen exhaust flowing there though. The difference in back pressure compensates for the difference in proximity between the first and second portions 410a, 410b and the exhaust conduit 316. As a result, the oxygen exhaust flow through the air recuperator 112 may be more uniform.

In an alternative embodiment, a similar result may be achieved by varying the diameters of the through holes 404 rather than varying the density of the through holes 404. For example, the first and second portions 410a, 410b may have the same number of through holes 404, with the through holes 404 of the second portion 410b having a larger size (e.g., diameter) than the through holes 404 of the first portion 410a. In another embodiment, both the density and diameter of the through holes 404 may differ between the first and second portions 410a, 410b.

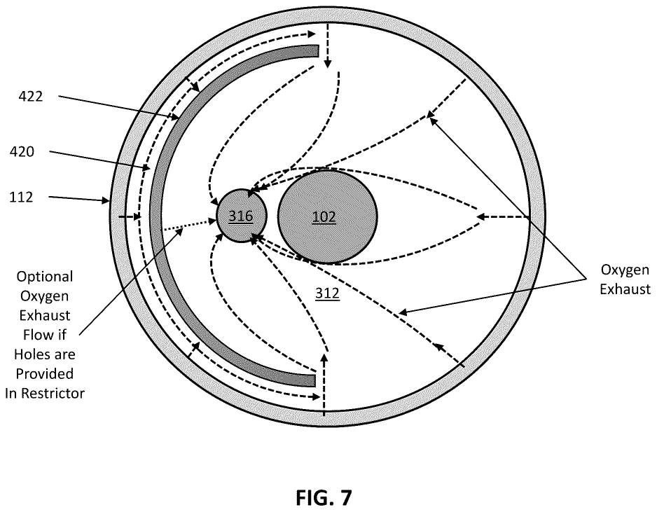

FIG. 7 is a schematic top view of a hotbox 300 including another alternative exhaust restrictor 420, according to various embodiments of the present disclosure. Referring to FIG. 7, the exhaust restrictor 420 may have an arcuate body 422 that may optionally include through holes. The exhaust restrictor 420 may be disposed between the radial sector of the outlet of the air recuperator 112 that is relatively close to the exhaust conduit 316. As such, the exhaust restrictor 420 may partially or completely restrict oxygen flow through the relatively short routes between the air recuperator 112 and the exhaust conduit 316, while oxygen exhaust is permitted to flow along the relatively long routes between the air recuperator 112 and the exhaust conduit 316 without any restriction from the exhaust restrictor 420.

In various embodiments, electrolyzer systems include a single oxygen exhaust conduit and an oxygen exhaust restrictor configured to increase back pressure of the oxygen exhaust flow into the exhaust conduit by inducing a pressure drop in the oxygen exhaust. This configuration may allow for a reduction in manufacturing costs, as compared to hotboxes having two or more oxygen exhaust conduits. The exhaust restrictor may also reduce the electrolyzer cell pressure differential between air and fuel sides of the electrolyzer cells, which leads to increased cell and stack lifetimes.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

1. An electrolyzer system, comprising:
a hotbox;
stacks of electrolyzer cells located in the hotbox and configured to receive steam and air, and to output a hydrogen stream and an oxygen exhaust;
an air recuperator heat exchanger surrounding the stacks in the hotbox and configured to heat the air received by the stacks by extracting heat from the oxygen exhaust output from the stacks;
an exhaust conduit configured to output the oxygen exhaust from the hotbox; and
an exhaust restrictor configured to increase back pressure of oxygen exhaust flow between an outlet of the air recuperator heat exchanger and the exhaust conduit.

2. The electrolyzer system of claim 1, wherein the exhaust restrictor is located above the air recuperator heat exchanger.

3. The electrolyzer system of claim 1, wherein the exhaust restrictor comprises:
a cylindrical body; and
through holes that extend through the cylindrical body, and configured to generate a circular oxygen exhaust flow in the air recuperator heat exchanger.

4. The electrolyzer system of claim 3, wherein the through holes are uniformly distributed on the cylindrical body, and the through holes have a circular or non-circular shape.

5. The electrolyzer system of claim 3, wherein the through holes are non-uniformly distributed on the cylindrical body, and the through holes have a circular or non-circular shape.

6. The electrolyzer system of claim 5, wherein:
the exhaust restrictor is divided into a first portion that is disposed relatively close to the exhaust conduit and a second portion that is disposed relatively far from the exhaust conduit; and
the first portion has a lower density of the through holes than the second portion.

7. The electrolyzer system of claim 3, wherein:
the exhaust restrictor is divided into a first portion that is disposed relatively close to the exhaust conduit and a second portion that is disposed relatively far from the exhaust conduit; and
the through holes are smaller in the first portion than in the second portion.

8. The electrolyzer system of claim 3, further comprising:
an inner cover plate disposed over the stacks and the air recuperator heat exchanger; and
a cover support disposed under the inner cover plate and surrounded by the exhaust restrictor, the cover support configured to at least partially define an oxygen exhaust flow space through which the oxygen exhaust flows from the exhaust restrictor to the exhaust conduit.

9. The electrolyzer system of claim 8, further comprising an outer cover plate disposed on the hotbox and over the inner cover plate, wherein the exhaust conduit extends through the inner cover plate and the outer cover plate.

10. The electrolyzer system of claim 1, wherein the exhaust conduit comprises the only oxygen exhaust conduit of the hotbox.

11. The electrolyzer system of claim 10, wherein:
the electrolyzer cells comprise solid oxide electrolyzer cells; and
the hotbox comprises a cylindrical hotbox, and the exhaust conduit is radially offset from a central vertical axis of the hotbox.

12. The electrolyzer system of claim 1, further comprising a central column surrounded by the stacks, the central column comprising:
air preheater heat exchanger configured to preheat the air received by the stacks;
a steam recuperator heat exchanger configured to heat the steam by extracting heat from the hydrogen stream output from the stacks; and
a steam heater surrounded by the steam recuperator heat exchanger.

13. A method of operating an electrolyzer system, comprising:
providing steam and air to stacks of electrolyzer cells located in a hotbox to generate a hydrogen stream and an oxygen exhaust;
heating the air provided to the stacks by extracting heat from the oxygen exhaust output from the stacks in an air recuperator heat exchanger surrounding the stacks in the hotbox;
flowing the air exhaust from the air recuperator heat exchanger though an exhaust restrictor which increases back pressure of the oxygen exhaust flow; and
outputting the oxygen exhaust from the hotbox through an exhaust conduit.

14. The method of claim 13, wherein:
the exhaust restrictor generates a pressure drop ranging from about 0.2 psi to about 0.6 psi in the oxygen exhaust;
the exhaust restrictor reduces a pressure difference between air sides and fuel sides of the electrolyzer cells to 0.1 psi or less; and
the oxygen exhaust comprises an oxygen enriched air exhaust stream.

15. The method of claim 13, wherein the exhaust restrictor comprises:
a cylindrical body located above the air recuperator heat exchanger; and
through holes that extend through the cylindrical body.

16. The method of claim 15, wherein the exhaust restrictor generates a circular oxygen exhaust flow in the air recuperator heat exchanger.

17. The method of claim 15, wherein the through holes are uniformly distributed on the cylindrical body.

18. The method of claim 15, wherein the through holes are non-uniformly distributed on the cylindrical body.

19. The method of claim 13, wherein the exhaust conduit comprises the only oxygen exhaust conduit of the hotbox.

20. The method of claim 19, wherein:
the electrolyzer cells comprise solid oxide electrolyzer cells; and
the hotbox comprises a cylindrical hotbox, and the exhaust conduit is radially offset from a central vertical axis of the hotbox.
